(19) United States
(12) Patent Application Publication
(10) Pub. No.: US 2018/0345050 A1
(43) Pub. Date: Dec. 6, 2018

(54) PROTECTIVE GARMENT FOR NUCLEAR AND TOXIC ENVIRONMENTS

(71) Applicant: International Enviroguard, Inc., Mesquite, TX (US)

(72) Inventor: Gary L. COX, Mesquite, TX (US)

(21) Appl. No.: 15/960,641

(22) Filed: Apr. 24, 2018

Related U.S. Application Data
(60) Provisional application No. 62/515,956, filed on Jun. 6, 2017.

(51) Int. Cl. A62B 17/00; A41D 13/02; A41D 27/20; A43B 3/16; D04H 3/16; D04H 3/007; B32B 5/02; A62B 9/04; G21F 3/025

(52) U.S. Cl. CPC A62B 17/006; B32B 2250/03; A41D 27/201; A43B 3/16; D04H 3/16; D04H 3/007; B32B 5/022; A62B 9/04; G21F 3/025; A41D 2200/20; A41D 2300/322; A41D 2300/32; A41D 2300/324; A41D 2400/52; A41D 2400/22; A41D 2400/60; A41D 2300/52; A41D 2500/30; D10B 2501/04; D10B 2321/022; B32B 2250/40; B32B 2307/724; B32B 2307/7265; B32B 2262/0253; B32B 2307/718; A41D 13/02

(57) ABSTRACT

A protective garment, including a double protective garment, for working in radioactive, nuclear, and/or toxic environments, wherein the main body has a rear surface and the rear surface comprises a reversible opening which is adapted to allow a SCBA (self-contained breathing apparatus) tank to be removed and replaced while the user continues to wear the protective garment. The reversible opening can be a zipper, including a double zipper. The protective garment is formed of a tri-laminate 30/30/30 water resistant barrier fabric. The garment can be incinerated so as to provide a disposable, one time use coverall particularly adapted for use in nuclear/radioactive environments. The coverall provides integrated elements for water resistance (i.e., splash resistant), breathable, comfortable contamination protection with a high volume of water vapor transfer which can mitigate worker heat stress. It is adapted for use with various types of breathing apparatuses, included external air lines, back-mounted SCBAs, and emergency breathing bottles or apparatuses. Air tanks and bottles are covered by the garment and thus do not need to be decontaminated. The garment also can include elements for use with air sampling devices and/or dosimetry equipment that are often worn by such workers.

### BACKGROUND

Protective garments are desperately needed for people working in dangerous nuclear, radioactive, and toxic environments. The need for protective garments is particularly acute for nuclear and radioactive environments. For example, plutonium production can create the need for nuclear waste tanks which may leak, creating a need for cleaning up of radioactive and toxic waste. Protective garments must provide excellent, durable protection for protection of the user, as well as convenience and comfort for the user.

Generally, what would be additionally desirable is a disposable, limited use garment for universal application in toxic and radioactive environments such as found in the nuclear industry for both indoor and outdoor applications which provides integrated elements for breathable, water resistant, comfortable contamination protection for use with external air hoses, a back-mounted self-contained breathing apparatus (SCBA), an emergency breathing apparatus (e.g., SKA-PAK®), air sampling equipment and/or dosimetry equipment.

In one example, U.S. Pat. No. 7,971,270 describes one such protective garment. Despite the advantages found in the protective garment described in U.S. Pat. No. 7,971,270, a need exists for improvements including the ability to work quickly and efficiently so as to protect the user health while achieving higher productivity. More particularly, better garments are needed which allow for faster exchange of self-contained breathing apparatuses (SCBAs).

### SUMMARY

Embodiments described and/or claimed herein include protective garments, as well as methods of making protective garments and methods of using protective garments.

For example, one aspect provides for a protective garment, comprising:

a body garment formed of barrier fabric comprising a main body, a pair of legs, a pair of arms, and a hood, wherein:

the main body has a front surface and a rear surface and wherein the main body comprises:

a zipper opening on the front surface sufficient for a user to enter and exit the garment;

a plurality of dosimetry tabs arranged on the front surface of the main body;

a sealed inlet opening for an air line;

an expanded portion containing a pouch sized for encompassing an emergency escape air bottle; and

an expanded section on the rear surface sized to encompass a user-worn self-contained breathing apparatus (SCBA) tank;

each leg of the pair of legs has a distal portion proximate to an ankle of a user of the protective garment and wherein each leg comprises:

attached boots; and

elastic encircling the distal portion;

each arm of the pair of arms has a distal portion proximate to a wrist of a user of the protective garment and comprises elastic encircling the distal portion; and

the hood comprises a drawstring opening,

wherein the rear surface further comprises a reversible opening which is adapted to allow the SCBA tank to be removed and replaced while the user continues to wear the protective garment.

In one embodiment, the reversible opening is a zipper. In one embodiment, the reversible opening is a double zipper. In one embodiment, the reversible opening is U-shaped.

In one embodiment, the garment is a double garment comprising an inner garment and an outer garment. In one embodiment, the garment is a single garment.

In one embodiment, the barrier fabric is a breathable laminated fabric. In one embodiment, the breathable laminated fabric consists of: an outer layer of spunbond polypropylene having a weight of 30 grams per square meter; a middle layer of microporous film having a weight of 30 grams per square meter; and an inner layer of spunbond polypropylene having a weight of 30 grams per square meter; wherein the outer, middle, and inner layers are laminated together to produce a breathable, water resistant barrier fabric.

In one embodiment, the plurality of dosimetry tabs comprises a first pair of dosimetry tabs arranged on the front surface proximate to the chest of the user of the protective garment and a second pair of dosimetry tabs arranged on the front surface proximate to the waist of the user of the protective garment.

In one embodiment, the main body further comprises top portions proximate to the shoulders of a user of the protective garment and wherein the protective garment further comprises an air line loop on each top portion.

In one embodiment, the garment further comprises: at least one slit opening between a shoulder and a chest dosimetry tab, and a flap with a hook and loop closure for covering the slit opening. In one embodiment, the at least one slit opening is a horizontal slit opening. In one embodiment, the at least one slit opening is a diagonal slit opening.

In one embodiment, the garment further comprises a sewn-in pocket including a flap with a hook and loop closure, the pocket being located in a lower portion of the front surface.

In one embodiment, the garment further comprises a pair of open-top pockets formed in a lower portion of the rear surface.

In one embodiment, the sealed inlet opening for an air line comprises a longitudinally-extending tubular section of fabric having a diameter slightly greater than an air line hose diameter.

Another aspect provides for a protective garment, comprising:

a body garment formed of barrier fabric comprising a main body, a pair of legs, a pair of arms, and a hood, wherein:

the main body has a front surface and comprises:

a zipper opening on the front surface sufficient for a user to enter and exit the garment;

each leg of the pair of legs has a distal portion proximate to an ankle of a user of the protective garment and wherein each leg comprises:

attached boots; and

elastic encircling the distal portion;

each arm of the pair of arms has a distal portion proximate to a wrist of a user of the protective garment and comprises elastic encircling the distal portion; and

the hood comprises a drawstring opening, and

wherein the barrier fabric consists of:

an outer layer of spunbond polypropylene having a weight of 30 grams per square meter;

a middle layer of microporous film having a weight of 30 grams per square meter; and

an inner layer of spunbond polypropylene having a weight of 30 grams per square meter;

wherein the outer, middle, and inner layers are laminated together to produce a breathable, water resistant barrier fabric,

wherein the main body has a rear surface and the rear surface comprises a reversible opening which is adapted to allow an SCBA tank to be removed and replaced while the user continues to wear the protective garment.

In one embodiment, the main body further comprises: a rear surface; top portions proximate to the shoulders of a user of the protective garment; an air line loop on each top portion; a sealed inlet opening for an air line; an expanded portion containing a pouch sized for encompassing an emergency escape air bottle; and an expanded section on the rear surface sized to encompass a user-worn self-contained breathing apparatus (SCBA) tank.

In one embodiment, the garment further comprises a first pair of dosimetry tabs arranged on the front surface proximate to the chest of the user and a second pair of dosimetry tabs arranged on the front surface proximate to the waist of the user.

In one embodiment, the garment further comprises: at least one slit opening between a shoulder and one of the pair of chest dosimetry tabs, and a flap with a hook and loop closure for covering the slit opening. In one embodiment, the at least one slit opening is a horizontal slit opening. In one embodiment, the at least one slit opening is a diagonal slit opening.

In one embodiment, the garment further comprises a sewn-in pocket including a flap with a hook and loop closure, the pocket being located at a lower portion of the front surface of the main body.

In one embodiment, the garment further comprises a pair of open-top pockets formed in a lower portion of the rear surface of the main body.

In one embodiment, the sealed inlet opening for an air line comprises a longitudinally-extending tubular section of fabric having a diameter slightly greater than an air line hose diameter.

In one embodiment, the body garment is a double garment. In one embodiment, the body garment is a single garment.

Another aspect includes a method comprising removing and replacing at least one SCBA tank on a user who is using the protective garment as described and/or claimed herein while the user continues to wear the protective garment.

Another aspect includes a method comprising a person wearing a protective garment as described and/or claimed herein while working in a nuclear and/or radioactive and/or toxic environment.

Another aspect includes a method comprising fabricating at least one protective garment as described and/or claimed herein.

At least one advantage in at least one embodiment is to allow the wearer to be continually protected while the SCBA bottles are being removed and replaced. An additional advantage for at least one embodiment includes that the worker can be rehydrated to reduce heat stress and receive further instructions while the bottle is being replaced by a co-worker. An additional advantage for at least some embodiments is the result of a special tri-laminated fabric design which allows a high moisture vapor transmission rate that reduces heat stress for the wearer. Still further, at least one additional advantage in at least one embodiment is increased productivity, such as, for example, at least 15%, or at least 20%, or at least 25% increase in productivity. For example, a worker may be able to change (or have changed) the SCBA tank in 5-7 minutes rather than 20-40 minutes. Also provided herein is a one piece garment with two separate compartments, which provides a more simple inventory compared to a system comprising two or more pieces of garment.

In general, the garment incorporates many safety features not readily found in other garments such as, for example, the special tri-laminate fabric which reduces heat stress, dosimeter tabs to hold various dosimeters in various positions on the garment to measure levels of radiation or toxins, hook and loop closures on all garment penetrations to allow for emergency breathing tubes, and/or air line loops to hold the air line for the user.

Other advantages and combination of advantages are described and implicitly present in this application.

### BRIEF DESCRIPTION OF THE DRAWINGS

The figures are for illustration only and are not drawn to scale.

FIG. 1 illustrates a front view of a preferred embodiment of a coverall;

FIG. 2 illustrates a rear view of a preferred embodiment of a coverall;

FIG. 3 illustrates a detail of a tri-laminate fabric.

FIG. 4 illustrates a preferred embodiment for the reversible opening of the rear surface (e.g., zipper), showing when the opening is closed (e.g., the zipper is zipped shut, when the user is working and using the SCBA).

FIG. 5 illustrates a preferred embodiment for the reversible opening of the rear surface (e.g., zipper), showing when the opening is opened (e.g, zipper is zipped open, when the user is having the SCBA removed and replaced with the help of another person).

### DETAILED DESCRIPTION

### Introduction

Additional details for the claimed inventions are provided in the following detailed description.

All references cited herein are incorporated by reference in their entirety to the extent that they do not contradict the teachings of this patent application.

Protective garments are known in the art. See, for example, U.S. Pat. Nos. 7,203,974; 6,792,625; 6,460,198; 6,047,413; 5,626,947; 5,279,287; 4,943,475; 4,901,370; and 4,864,654.

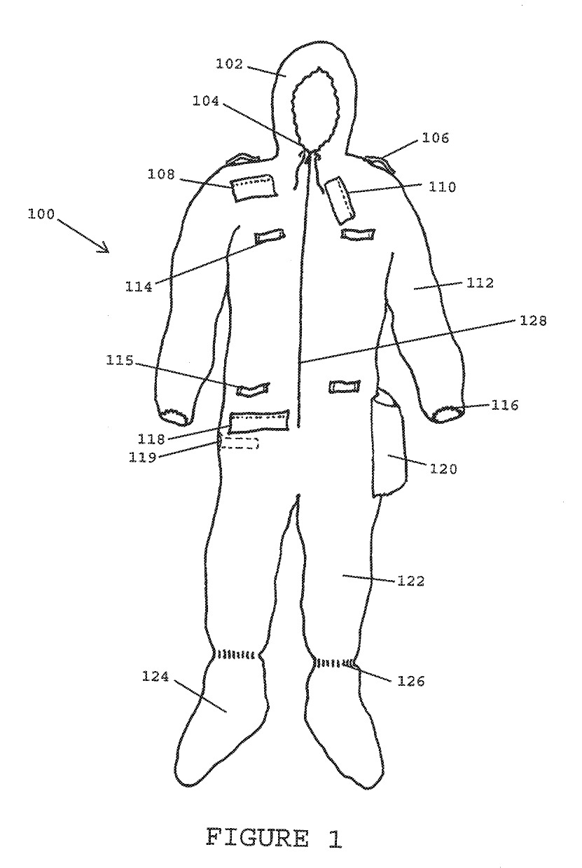

U.S. Pat. No. 7,971,270 is incorporated herein by reference in its entirety including its figures, description of the figures, claims, and all other embodiments. Some embodiments are expressly recited in this detailed description. For example, FIGS. 1-3 from U.S. Pat. No. 7,971,270 are reproduced herein. The protective garments described and/or claimed in U.S. Pat. No. 7,971,270 can be improved with use of a reversible opening, as described and claimed hereinbelow.

Protective garments can be reusable or disposable, but disposable protective garments are preferred, particularly for radioactive and toxic waste treatment applications.

As known in the art, the protective garment can comprise an inner garment and also an outer garment. After putting on the protective garment, the user can first zip the inner garment, followed by zipping the outer garment.

The protective garment, including the fabrics and seams used to make the garment, can be adapted to provide for chemical splash resistance. Particularly preferred fabrics include those providing for a high level of chemical resistance while providing a high volume of water or moisture transmission commonly known as MVTR or WVTR in order to mitigate heat stress. Particularly preferred seams include welded seams and bound sewn seams.

Generally speaking, the seams and points of attachment in the protective garment may be formed by any suitable methods, mechanisms, and/or devices such as, for example, by sewing or stitching, taping, ultrasonic bonding, solvent welding, adhesives, thermal bonding and the like. The closure methods, mechanisms, and/or devices may be any suitable closure mechanism such as, for example, zippers, button fasteners, dip fasteners, snap fasteners, hook and loop fasteners, resealable tapes, ziplock fasteners, magnetic fasteners and the like. Various portions of the garment may be joined or attached by sewing or stitching, ultrasonic bonding, solvent welding, adhesives, thermal bonding and similar techniques.

For convenience, the protective garment can comprise thumb loops to make putting on and taking off the protective garment easier. The thumb loops can prevent the inner sleeve from sliding up the arm when donning the outer sleeve.

The color of the protective garment can be varied, but in a preferred embodiment, the protective garment is a white protective garment.

### Reversible Opening

The protective garment, including those described in U.S. Pat. No. 7,971,270, is adapted so that the rear surface further comprises a reversible opening which is adapted to allow the SCBA (self-contained breathing apparatus”) tank to be removed and replaced while the user continues to wear the protective garment. The reversible opening is positioned and sized to allow such removal and replacement while the user continues to wear the protective garment.

The reversible opening can be, for example, a zipper, or other fasteners such as, for example, snaps, clasps, clips, buttons, hooks and loops, and strings. The zipper is most preferred as providing for the best seal.

Zippers are generally known in the art. As known in the art, zippers can be zipper assemblies in which subcomponents are designed to function together in an operational zipper. For example, U.S. Pat. No. 6,792,625 describes examples of zippers. The zipper must be adapted to allow the protective garment to function for the intended use and protection of the user, e.g., be impervious, gas-tight, fluid-tight, and/or otherwise chemically resistant to the radioactive hazards. The zippers can be adapted to include flap covers.

The reversible opening is adapted to be large enough to allow the SCBA tank to be removed and replaced but generally will not be adapted to allow the user to remove the suit. The size or length of the reversible opening should be limited. Rather, a zipper on the front side such as 128 in FIG. 1 can be used to remove the suit. The reversible opening can be located only on the main body portion of the back side, and is not located on the pair of legs, the pair of arms, and/or the hood. The reversible opening can be two way and can provides easier operation by either a right or left handed person.

As known in the art, the zipper can be a single zipper or a double zipper. Left-handed or right-handed zippers can be used.

The zipper can have a variety of shapes but in some embodiments can be a generally U-shaped zipper. This can create a flap which can fold out when the zipper is opened, but the zipper remains attached to the protective garment.

In one embodiment, the garment is a double garment comprising an inner garment and an outer garment.

In one embodiment, the garment is a single garment.

The SCBA bottle can be located in its own compartment, not attached to the wearer inside the garment.

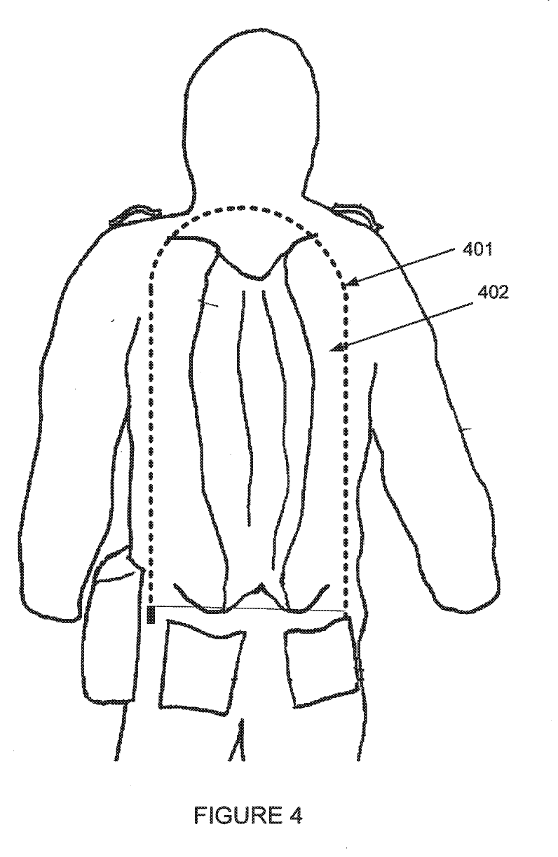

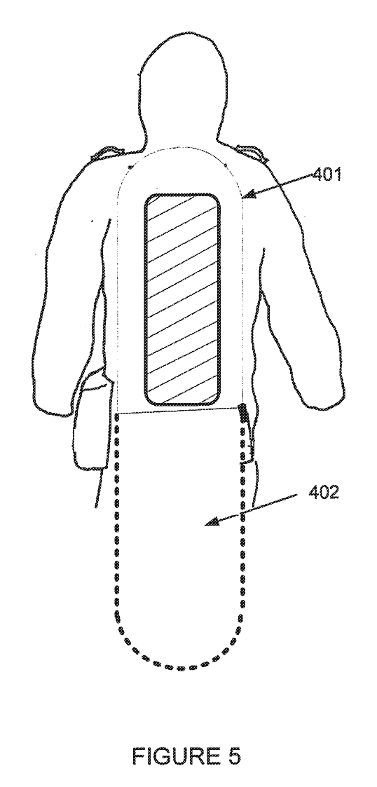

### Embodiments of FIGS. 4 and 5

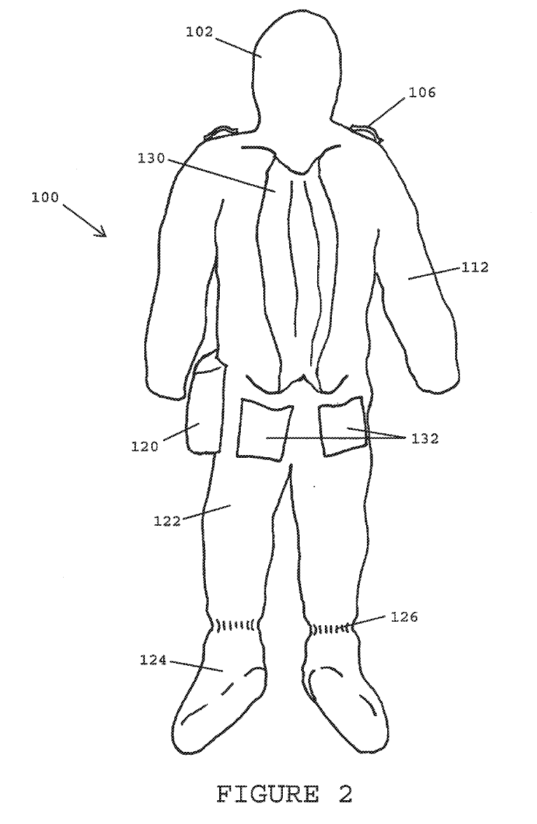

Finally, FIGS. 4 and 5 illustrate preferred embodiments for the reversible opening on the back. FIGS. 4 and 5 show rear views of the protective garment, as is shown in FIG. 2. The zipper, as a preferred embodiment for the reversible opening, is shown as the dotted line, 401. The zipper creates a flap, shown as element 402. In FIG. 4, the zipper is closed. In FIG. 5, the zipper is opened and the flap folded away from the protective garment. In FIG. 5, an SCBA air tank is also shown. This air tank can be removed and replaced when the flap is folded away. A second person can help the user to have the air tank removed and replaced, while the user of the protective garment remains in and continues to wear the protective garment. Hence, the user does not have to remove the protective garment to change the SCBA tank, which creates large efficiencies.

### Methods of Making

Methods known in the art, such as for example, sewing, can be used to fabricate the protective garments described and/or claimed herein.

### Methods of Using

The protective garments as described and/or claimed herein can be used in methods of clean-up, decontamination, remediation, removal, maintenance, and other beneficial tasks, particularly for nuclear and/or radioactive and/or toxic environments. Toxic applications can include, for example, fire damage environments, black water damage, chemical spills, low level radioactive nuclear environments, as well as chemical, nuclear, bio-nuclear, and radiological environments, (CBRN), and the like.

The suit can be adapted for the particular method of use and application.

In particular, one method comprises removing and replacing at least one SCBA tank on a user who is wearing the protective garment as described and/or claimed herein while the user is wearing the protective garment. One or more additional persons can assist with the removing and replacing steps.

In particular, another method comprises a person wearing a protective garment as described and/or claimed herein working in a nuclear and/or radioactive and/or toxic environment.

### Additional Embodiments

Additional description is provided including embodiment as previously described in U.S. Pat. No. 7,971,270, including FIGS. 1-3 which can be integrated into the presently claimed inventions.

Embodiments disclosed herein provide a disposable, one time use coverall particularly adapted for use in nuclear/radioactive environments. The coverall is a disposable garment that can be incinerated for disposal. The garment provides integrated elements for water resistant (i.e., splash resistant), breathable, comfortable contamination protection for use with various types of breathing apparatuses, included external air lines, back-mounted self-contained breathing apparatuses (SCBA), and emergency breathing bottles or apparatuses (e.g., SKA-PAK®). The garment also includes elements for use with air sampling devices and/or dosimetry equipment that are often worn by such workers.

In an embodiment, the coverall is a made of a tri-laminate 30/30/30 water resistant fabric which can be fabricated in various colors. The tri-laminate 30/30/30 fabric comprises 30 grams per square meter of spunbond polypropylene, 30 grams per square meter of microporous film and 30 grams per square meter of spunbond polypropylene that are laminated together to produce a breathable, water resistant fabric. The coverall includes a zipper front, lock stitch/ultrasonically welded seams, and an expanded back for a self contained breathing apparatus (SCBA). The coverall has an attached draw string hood for covering the head and drawing tight against a breathing mask. To prevent contamination from other openings, the coverall includes attached boots with elastic at the ankle and sleeves with elastic at the wrists.

In another embodiment, and to provide for additional equipment, the coverall includes air line loops attached on top of shoulders, dosimeter tabs on the left and right front chest, approximately 11″ down from top of the shoulder, and dosimeter tabs on the left and right front waist, approximately 26″ from top of shoulder for the average size garment, with actual placement adjusted for garment size. The coverall further includes an approximately 4″ wide slit on the right front of the garment between the shoulder and breast, placed horizontally with a hook and loop closure fastened flap, an emergency bottle (e.g., SKA-PAK®) pouch (approximately 10″ tall, 8″ wide and 8″ deep) on left hip, a sealed opening with a 1″ diameter and a 4″ long sleeve for airline access on right hip, an approximately 4″ opening w with a hook and loop closure fastened flap positioned approximately 1″ from the front zipper and placed diagonally approximately 3-4″ from top of left shoulder, an approximately 7″ wide slit with an attached sewn-in pocket with a hook and loop closure on the right front hip, and two rear hip pockets (approximately 7″×7″) with openings at the top that do not include any closure means.

The tri-laminate fabric used in an embodiment eliminates the need for multiple layers and improves comfort by being thin and breathable (i.e., vapor permeable based on the microporous film). The inclusion of multiple features allow a single, universal coverall to be used in multiple applications in facilities such as toxic and nuclear waste environments, including both indoor and outdoor environments, thus simplifying the number of different coveralls that a facility needs to stock. The coverall also simplifies disposal requirements for the facility since all used coveralls can simply be incinerated for disposal.

Additional, more detailed description is provided.

One embodiment of a protective garment (also can be called a “coverall”) for use in nuclear environments, is disclosed in FIG. 1, which illustrates a front view of the coverall 100. The coverall 100 is constructed from a tri-laminate 30/30/30 water resistant fabric which can be fabricated in various colors. Preferred construction techniques include lock stitch/ultrasonically welded seams, although other methods, such as use of serged seams or a two-needle felled stitch with taped seams, are also contemplated. The coverall 100 includes a hood 102, sleeves 112, and legs 122 that are attached to the body portion of the coverall 100 and are accessed by a user through a front opening operated by a zipper 128. The front of hood 102 has a draw string opening 104 for drawing the hood 102 tight against a breathing mask. To prevent contamination from other openings, the legs 122 of the coverall include attached boots 124 with elastic 126 at the ankle, and the sleeves 112 include elastic 116 at the wrists. The elastic 116 and 126 also help keep the coverall 100 in position on the user.

The coverall 100 can be produced in various standard sizes to accommodate variously-sized users. The lightweight tri-laminate fabric that is held in place on a user by elastic 116 and 126 and drawstring 104 allows freedom of movement for the wearer in order for the wearer to complete their assigned task in the hazardous nuclear environment. The breathable nature of the tri-laminate fabric provides improved comfort in comparison to other barriers such as PVC nuclear suits or combinations such as cotton coveralls and PVC outerwear.

To provide for radiation monitoring equipment, the coverall 100 includes air dosimeter tabs 114 on the left and right front chest, approximately 11″ (˜28 cm) down from top of the shoulder of an average size garment, and dosimeter tabs 115 on the left and right front waist, approximately 26″ (˜66 cm) from the top of shoulder of the average size garment. The actual placement of the dosimeter tabs 114 and 115 on the front of coverall 100 should be adjusted for garment size, with placements proportionately closer to the shoulder for smaller sized and further away for larger sizes.

In addition to zipper 128, user access to the inside of the garment is provided by openings or slits 108 and 110. Slit 108 is approximately 4″ (˜10 cm) wide located on the right front of the garment between the shoulder and breast, placed horizontally with a hook and loop closure fastened flap. Slit 110 provides an approximately 4″ (˜10 cm) opening with a hook and loop closure fastened flap positioned approximately 1″ (˜2.5 cm) from the front zipper and placed diagonally approximately 3-4″ (˜7.5-10 cm) from top of left shoulder. Closing the flaps on slits 108 and 110 will allow the garment to be splashed. Slits 108 and/or 110 can be used in a variety of ways by a user, including but not limited to providing sampling access for user-carried air sampling devices.

Coverall 100 includes numerous elements to provide for use with a variety of breathing apparatuses. For use with external air lines or hoses, coverall 100 includes air line loops 106 attached on top of the shoulders to secure an air line to the user. The air line can then be fed into the coverall through sealed opening 119 that is formed as a 1″ (˜2.5 cm) diameter, 4″ (˜10 cm) long sleeve designed for air line access. Opening 119 is preferably positioned on the right hip of the coverall 100, but can be located in any suitable location.

The coverall 100 further includes an emergency bottle (e.g., SKA-PAK®) pouch 120 that is approximately 10″ (˜25 cm) tall, 8″ (˜20 cm) wide and 8″ (˜20 cm) deep), preferably on the left hip, as illustrated. In this manner, an emergency bottle with breathing air can be carried by the user in a manner that does not interfere with the user's mobility and does not require decontamination of the bottle for subsequent use.

The front of coverall 100 also preferably includes an approximately 7″ (˜17.8 cm) wide slit 118 with an attached sewn-in pocket with a hook and loop closure on the right front hip (although other locations are also anticipated). Slit 118 and its associated pocket allow for storage of small items that might be needed by a user (e.g., keys, gauges, rules, etc.), but frees the user's hands and protects the items from contamination if the items are not used.

As illustrated in the rear view of coverall 100 in FIG. 2, two rear hip pockets 132 can also be provided for items the user may need to carry and access quickly. The approximately 7″×7″ (˜17.8 cm×17.8 cm) pockets 132 have openings at the top that do not include any closure means. These pockets 132 can be used in many ways, but preferably are used with disposable items that can be later incinerated, such as paper diagrams/instructions or wipes/shop-rags.

FIG. 2 also illustrates an expanded back portion 130 of coverall 100 to provide room inside the garment for a self contained breathing apparatus (SCBA) to be worn on the users back. By allowing the SCBA equipment to be worn inside the coverall 100, the need to decontaminate the majority of the SCBA equipment (i.e., everything except for the exposed mask) can be eliminated. While illustrated in a particular configuration, numerous configurations (pleated, rectangular, cylindrical, etc.) for the expanded back portion 130 can be used without departing from the invention.

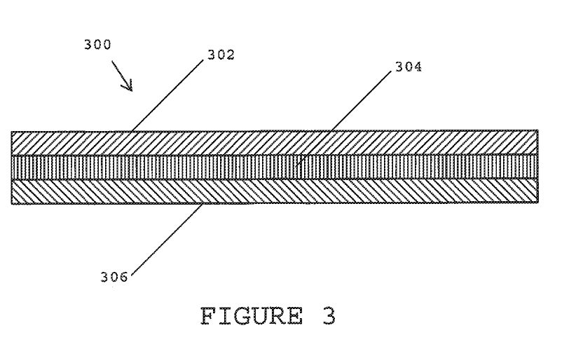

As illustrated in FIG. 3, the tri-laminate 30/30/30 water resistant fabric 300 comprises 30 grams per square meter of spunbond polypropylene 302, 30 grams per square meter of microporous film 304 and 30 grams per square meter of spunbond polypropylene 306 that are laminated together to produce a breathable, water resistant fabric 300. The microporous film 304 has openings sized to allow water vapor to pass through so as to increase wearer comfort, but which are sufficiently small to prevent the passage of liquid such as water.

The outer spunbond polypropylene layer 302 of the tri-laminate fabric 300 of the coverall 100 can be colored, dyed, or printed as required by the end-user. For example, various colors or other printed indicia can be used to indicate sizes so that users can quickly and easily select garments of the proper size. Similarly, workers on different teams or details can have garments of different colors so as to indicate the user's role.

An embodiment of a protective garment can comprise a body garment formed of barrier fabric. This body garment includes a main body, a pair of legs, a pair of arms, and a hood. The main body includes a front zipper opening that extends sufficiently down the front to allow a user to enter and exit the garment. The main body also has a plurality of dosimetry tabs on a front of the main body so that dosimetry badges or dosimeters can be attached thereto. More particularly, the tabs can be a pair of chest dosimetry tabs and a pair or waist dosimetry tabs.

To address various breathing air systems, the main body in this embodiment includes a sealed inlet opening for an air line, which can take the form of a longitudinally-extending tubular section of fabric having a diameter slightly greater than an air line hose diameter, an expanded portion containing a pouch sized for encompassing an emergency escape air bottle, and expanded section on the back or rear portion that is sized to encompass a user-worn self-contained breathing apparatus (SCBA) tank.

To address protection and fit, the pair of legs have attached boots and elastic at each ankle, the pair of arms have elastic at each wrist, and the hood includes a drawstring opening.

Variations on this embodiment include those wherein the barrier fabric is a breathable laminated fabric, and in particular wherein the breathable laminated fabric consists of an outer layer of spunbond polypropylene having a weight of 30 grams per square meter, a middle layer of microporous film having a weight of 30 grams per square meter, and an inner layer of spunbond polypropylene having a weight of 30 grams per square meter, wherein the outer, middle, and inner layers are laminated together to produce a breathable, water resistant barrier fabric.

Other variations on this embodiment include those having an air line loop on each shoulder of the main body, those with at least one slit opening between a shoulder and a chest dosimetry tab, and a flap with a hook and loop closure for covering the slit opening, which can be horizontal or diagonal.

Additional variations can include pockets, such as a sewn-in pocket including a flap with a hook and loop closure, the pocket being located a in a lower front portion of the main body, or a pair of open-top pockets formed in a lower rear portion of the main body.

Another embodiment of a protective garment can be a body garment formed of barrier fabric comprising a main body, a pair of legs, a pair of arms, and a hood. In this embodiment, the main body includes a front zipper opening sufficient for a user to enter and exit the garment, the pair of legs include attached boots and elastic at each ankle, the pair of arms includes elastic at each wrist, and the hood comprises a drawstring opening. For this embodiment, the barrier fabric consists of an outer layer of spunbond polypropylene having a weight of 30 grams per square meter, a middle layer of microporous film having a weight of 30 grams per square meter, and an inner layer of spunbond polypropylene having a weight of 30 grams per square meter, wherein the outer, middle, and inner layers are laminated together to produce a breathable, water resistant barrier fabric.

A variation of this embodiment includes breathing apparatus details, wherein the main body further includes an air line loop on each shoulder, a sealed inlet opening for an air line, which can be a longitudinally-extending tubular section of fabric having a diameter slightly greater than an air line hose diameter, an expanded portion containing a pouch sized for encompassing an emergency escape air bottle, and a rear expanded section sized to encompass a user-worn self-contained breathing apparatus (SCBA) tank. This variation can optionally include a pair of chest dosimetry tabs and a pair or waist dosimetry tabs on a front of the main body. It can also include a slit opening between a shoulder and a chest dosimetry tab, and a flap with a hook and loop closure for covering the slit opening, where the slit opening can be horizontal or diagonal.

Another variation of this embodiment includes pocket, which can take the form of a sewn-in pocket including a flap with a hook and loop closure, the pocket being located a in a lower front portion of the main body, or a pair of open-top pockets formed in a lower rear portion of the main body.

A protective garment for nuclear environments has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

1. A protective garment, comprising:
a body garment formed of barrier fabric comprising a main body, a pair of legs, a pair of arms, and a hood, wherein:
the main body has a front surface and a rear surface and wherein the main body comprises:
a zipper opening on the front surface sufficient for a user to enter and exit the garment;
a plurality of dosimetry tabs arranged on the front surface of the main body;
a sealed inlet opening for an air line;
an expanded portion containing a pouch sized for encompassing an emergency escape air bottle; and
an expanded section on the rear surface sized to encompass a user-worn self-contained breathing apparatus (SCBA) tank;
each leg of the pair of legs has a distal portion proximate to an ankle of a user of the protective garment and wherein each leg comprises:
attached boots; and
elastic encircling the distal portion;
each arm of the pair of arms has a distal portion proximate to a wrist of a user of the protective garment and comprises elastic encircling the distal portion; and
the hood comprises a drawstring opening,
wherein the rear surface further comprises a reversible opening which is adapted to allow the SCBA tank to be removed and replaced while the user continues to wear the protective garment.

2. The protective garment of claim 1, wherein the reversible opening is a zipper.

3. The protective garment of claim 1, wherein the reversible opening is a double zipper.

4. The protective garment of claim 1, wherein the reversible opening is U-shaped.

5. The protective garment of claim 1, wherein the garment is a double garment comprising an inner garment and an outer garment.

6. The protective garment of claim 1, wherein the garment is a single garment.

7. The protective garment of claim 1, wherein the barrier fabric is a breathable laminated fabric.

8. The protective garment of claim 7, wherein the breathable laminated fabric consists of:
an outer layer of spunbond polypropylene having a weight of 30 grams per square meter;
a middle layer of microporous film having a weight of 30 grams per square meter; and
an inner layer of spunbond polypropylene having a weight of 30 grams per square meter;
wherein the outer, middle, and inner layers are laminated together to produce a breathable, water resistant barrier fabric.

9. The protective garment of claim 1, wherein the plurality of dosimetry tabs comprises a first pair of dosimetry tabs arranged on the front surface proximate to the chest of the user of the protective garment and a second pair of dosimetry tabs arranged on the front surface proximate to the waist of the user of the protective garment.

10. The protective garment of claim 1, wherein the main body further comprises top portions proximate to the shoulders of a user of the protective garment and wherein the protective garment further comprises an air line loop on each top portion.

11. The protective garment of claim 1, further comprising: at least one slit opening between a shoulder and a chest dosimetry tab, and a flap with a hook and loop closure for covering the slit opening.

12.-13. (canceled)

14. The protective garment of claim 1, further comprising a sewn-in pocket including a flap with a hook and loop closure, the pocket being located in a lower portion of the front surface.

15.-16. (canceled)

17. A protective garment, comprising:
a body garment formed of barrier fabric comprising a main body, a pair of legs, a pair of arms, and a hood, wherein:
the main body has a front surface and comprises:
a zipper opening on the front surface sufficient for a user to enter and exit the garment;
each leg of the pair of legs has a distal portion proximate to an ankle of a user of the protective garment and wherein each leg comprises:
attached boots; and
elastic encircling the distal portion;
each arm of the pair of arms has a distal portion proximate to a wrist of a user of the protective garment and comprises elastic encircling the distal portion; and
the hood comprises a drawstring opening, and
wherein the barrier fabric consists of:
an outer layer of spunbond polypropylene having a weight of 30 grams per square meter;
a middle layer of microporous film having a weight of 30 grams per square meter; and
an inner layer of spunbond polypropylene having a weight of 30 grams per square meter;
wherein the outer, middle, and inner layers are laminated together to produce a breathable, water resistant barrier fabric,
wherein the main body has a rear surface and the rear surface comprises a reversible opening which is adapted to allow an SCBA tank to be removed and replaced while the user continues to wear the protective garment.

18. The protective garment of claim 17, wherein the main body further comprises:
a rear surface;
top portions proximate to the shoulders of a user of the protective garment;
an air line loop on each top portion;
a sealed inlet opening for an air line;
an expanded portion containing a pouch sized for encompassing an emergency escape air bottle; and
an expanded section on the rear surface sized to encompass a user-worn self-contained breathing apparatus (SCBA) tank.

19. (canceled)

20. The protective garment of claim 1, further comprising: at least one slit opening between a shoulder and one of the pair of chest dosimetry tabs, and a flap with a hook and loop closure for covering the slit opening.

21.-25. (canceled)

26. The protective garment of claim 1, wherein the body garment is a double garment.

27. The protective garment of claim 1, wherein the body garment is a single garment.

28. A method comprising removing and replacing at least one SCBA tank on a user who is wearing the protective garment of claim 1 while the user continues to wear the protective garment.

29. A method comprising a person wearing a protective garment of claim 1 while working in a nuclear and/or radioactive and/or toxic environment.

30. A method comprising fabricating at least one protective garment according to claim 1.
